(19) United States
(12) Patent Application Publication
(10) Pub. No.: US 2013/0219194 A1
(43) Pub. Date: Aug. 22, 2013

(54) TEST APPARATUS AND METHOD FOR TESTING PCIE SLOT

(71) Applicants: YUAN-YUAN GONG, Shenzhen City (CN); ZHENG-QUAN PENG, Shenzhen City (CN); QIONG CAI, Shenzhen City, (CN)

(72) Inventors: YUAN-YUAN GONG, Shenzhen City (CN); ZHENG-QUAN PENG, Shenzhen City (CN); QIONG CAI, Shenzhen City, (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/535,686

(22) Filed: Jun. 28, 2012

(30) Foreign Application Priority Data
Feb. 16, 2012 (CN) 201210034876.9

(51) Int. Cl. G06F 13/14; G06F 1/26

(52) U.S. Cl. 713/300; 710/8

(57) ABSTRACT

A test apparatus and a method are provided for testing a peripheral component interconnect (PCIE) slot by simulating the disconnection and reconnection of a device in the slot. The test apparatus detects whether a PCIE slot is in fact connected to an external device, and if so simulates an action of removing the external device from the PCIE slot and an action of re-inserting the apparently removed external device back into the PCIE slot to test the slot, thereby replacing any manual disconnection and reconnection.

### BACKGROUND

1. Technical Field

The disclosure relates to test apparatuses and, more particularly, to a test apparatus and a method for testing a peripheral component interconnect (PCIE) slot by simulating the removal and replugging a device connected to the slot adapted for the apparatus.

2. Description of Related Art

In the course of testing a PCIE slot, a tester must manually cut off the power of the PCIE slot, connect an external device to the PCIE slot, then power on the PCIE slot. It is time-consuming and inconvenient to frequently pull and replug the external device from the PCIE slot for testing the PCIE slot.

Therefore, what is needed is a new test apparatus to overcome the described shortcoming.

### BRIEF DESCRIPTION OF THE DRAWINGS

FIG. 1 is a block diagram of a test apparatus in accordance with an exemplary embodiment.

FIG. 2 is a flowchart of a method of testing PCIE slot adapted for the test apparatus of FIG. 1.

### DETAILED DESCRIPTION

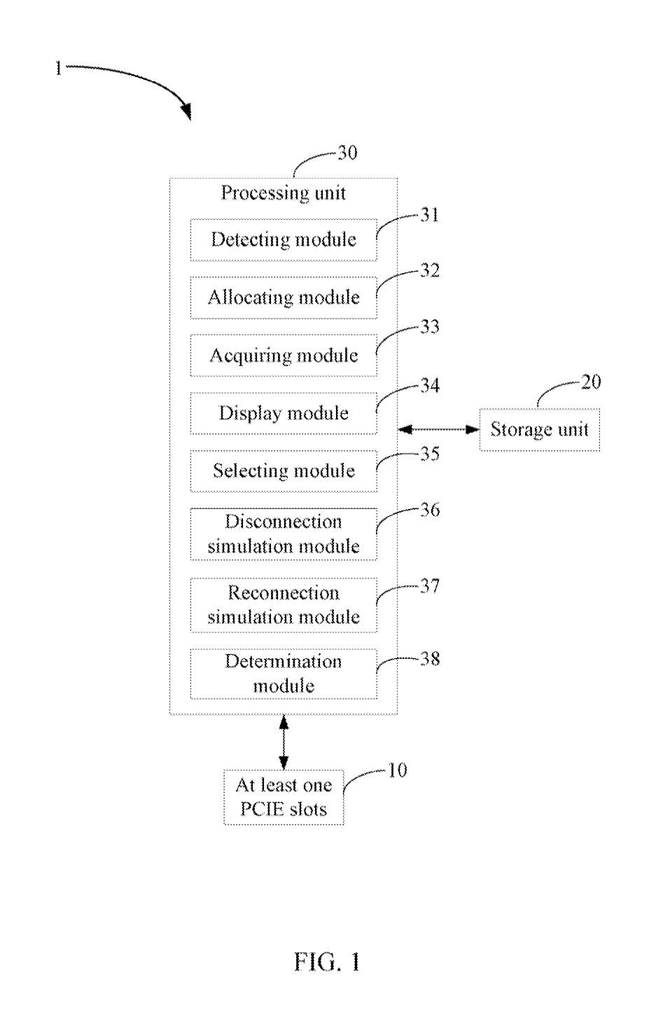

FIG. 1 is a block diagram of a test apparatus in accordance with an exemplary embodiment. The test apparatus 1 includes at least one PCIE slot 10, a storage unit 20, and a processing unit 30. The at least one PCIE slot 10 is fixed on the test apparatus 1 and is utilized for connecting with PCIE external devices. The storage unit 20 stores interface information of each of the at least one PCIE slot 10.

The processing unit 30 includes a detecting module 31, an allocating module 32, an acquiring module 33, a display module 34, a selecting module 35, a disconnection simulation module 36, a reconnection simulation module 37, and a determination module 38.

The detecting module 31 detects which PCIE slot 10 is connected to an external device (not shown). When the detecting module 31 detects that one PCIE slot 10 is connected to an external device, the allocating module 32 allocates a configuration space for the external device according to the PCIE standard which is well known and thus a description thereof is omitted. The storage unit 20 stores the configuration space. The configuration space stores information relating to the external device, such as a serial number of the external device and functional information.

For example, the configuration space of the external device further includes information as to bit status. The detecting module 31 detects whether a PCIE slot 10 is connected to an external device based on the bit status from the configuration space of the external device. When the bit status is a first value, for example “1”, the detecting module 31 detects that the PCIE slot 10 is connected to an external device, and when the bit status is a second value, for example “0”, the detecting module 31 determines that the PCIE slot 10 is not connected to an external device.

When the detecting module 31 determines that a PCIE slot is connected to an external device, the acquiring module 33 acquires the interface information of the PCIE slot 10 connected to the external device from the storage unit 20 and the information of the connected external device from the configuration space. For example, the detecting module 31 may detect that two PCIE slots 10 are each connected to one external device, and if so, the acquiring module 33 acquires the interface information of the two PCIE slots 10 and the information of the two external devices, for example, the interface information of one PCIE slot includes the fifth interface, the first external device, and the sixth function, that means that the fifth PCIE slot is connected to the first external device and performs the sixth function, and the interface information of the other PCIE slot includes the second interface, the second external device, and the first function, that means that the second PCIE slot is connected to the second external device and performs the first function.

The display module 34 displays the interface information of the PCIE slots 10 connected to the external devices and the information of the connected external devices. The selecting module 35 selects a PCIE slot 10 from all the PCIE slots 10 connected to the external devices detected by the detecting module 31, to test in response to user inputs. For example, the detecting module 31 detects that the second and the fifth PCIE slots are connected to the external devices, and the selecting module 35 selects the fifth PCIE slot to test in response to user inputs. If the detecting module 31 detects that only one PCIE slot is connected to the external device, both the display module 34 and the selecting module 35 do not perform this function.

When one PCIE slot 10 is connected to an external device, the disconnection simulation module 36 simulates an action of removing the external device from the PCIE slot 10 and detects the interface information of all PCIE slots connected to the external devices and the information of the connected external devices, wherein the information of the removed external device and the interface information of the removed PCIE slot are defined as simulation pulled information.

The reconnection simulation module 37 simulates an action of re-inserting or replacing the external device into the PCIE slot and detects the interface information of all PCIE slots connected to the external devices and the information of the connected external devices.

The determination module 38 compares a first information (as hereinafter explained) detected by the disconnection simulation module 36, and a second information (as hereinafter explained) detected by the reconnection simulation module 37 with a third information (as hereinafter explained) acquired by the acquiring module 33 to obtain a test result of the PCIE slot 10 connected to the external device. In other words, the determination module 38 compares the first information and the third information, and also compares the second information with the third information. The first information includes the interface information of the PCIE slots 10, the information of the external devices, and the simulation pulled information detected by the disconnection simulation module 36. The second information includes the interface information of the PCIE slots and the information of the external devices detected by the reconnection simulation module 37. The third information includes the interface information of all the PCIE slots 10 and the information of all the external devices acquired by the acquiring module 33.

When the determination module 38 determines that both the first information detected by the disconnection simulation module 36, and the second information detected by the reconnection simulation module 37 are the same as the third information acquired by the acquiring module 33, the test result of the connected PCIE slot is a pass.

When the determination module 38 determines that the first information and/or the second information is different from the third information acquired by the acquiring module 33, the test result of the connected PCIE slot is a fail.

Furthermore, the configuration space of each external device further includes three interrupt sources, a register value of each interrupt source, and power control bit information. The three interrupt sources include INTx, MSI, and MSI-x which are defined in the PCIE standard. The disconnection simulation module 36 acquires the three interrupt sources from the configuration space of each connected external device, changes the register value of each interrupt source to shield each interrupt source, and changes the power control bit information to power off the PCIE slot connected to the external device to simulate the action of removing the external device from the PCIE slot 10.

Furthermore, the reconnection simulation module 37 acquires the three interrupt sources from the configuration space of each connected external device, changes the register value of each interrupt source to open each interrupt source, and changes the power control bit information to power on the PCIE slot 10 connected to the external device to simulate the action of re-inserting or replacing the external device removed by the disconnection simulation module 36 into the same PCIE slot.

Therefore, the test apparatus 1 detects whether a PCIE slot 10 is connected to an external device, and when a PCIE slot 10 is in fact connected to an external device, the test apparatus 1 simulates an action of removing the external device from the PCIE slot 10 and then an action of re-inserting the removed external device into the same vacated PCIE slot to test all the PCIE slots, thereby replacing the manual disconnection and reconnection.

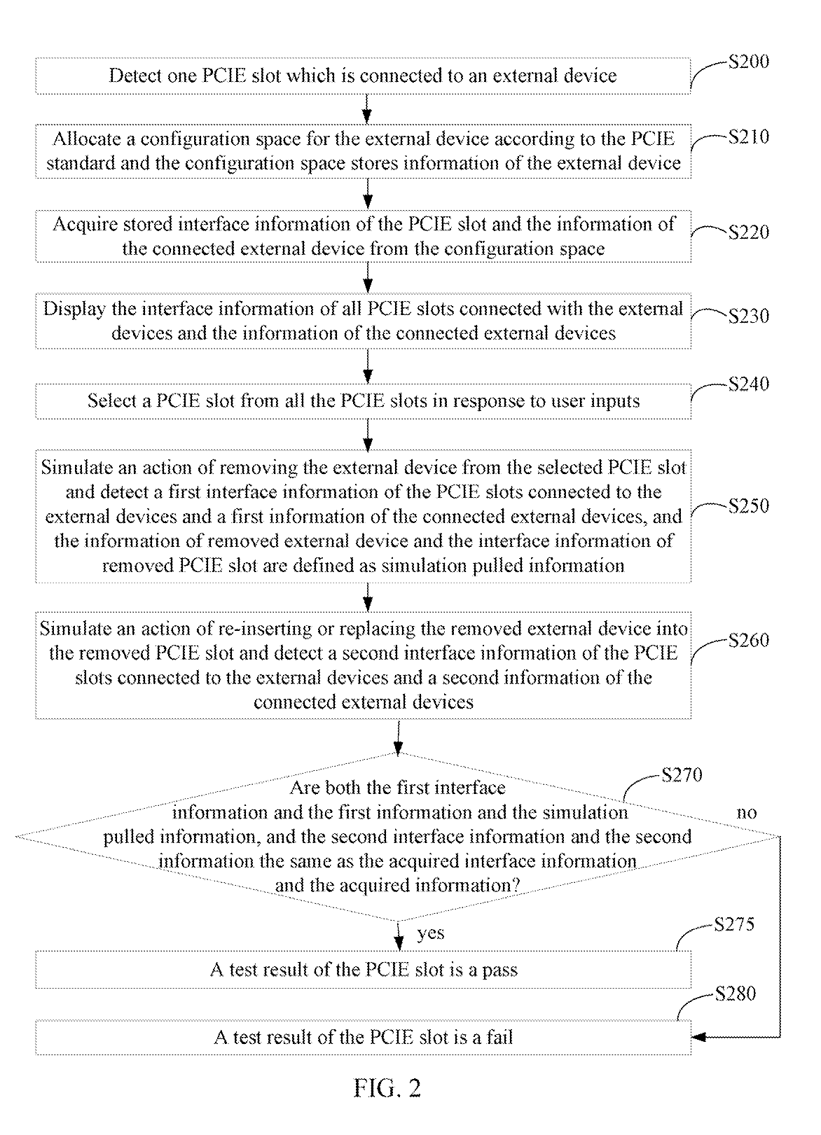

FIG. 2 is a flowchart of testing PCIE slot method adapted for the test apparatus of FIG. 1.

In step S200, the detecting module 31 detects at least one PCIE slot 10 which is connected to an external device. In step S210, the allocating module 32 allocates a configuration space for the external device according to the PCIE standard and the configuration space stores information of the external device.

In step S220, the acquiring module 33 acquires the interface information of the PCIE slot 10 connected to the external device from the storage unit 20 and the information of the connected external device from the configuration space. In step S230, the display module 34 displays the interface information of the PCIE slots 10 connected to the external devices and the information of the connected external devices. In step S240, the selecting module 35 selects a PCIE slot 10 from all the PCIE slots 10 which, according to the detecting module 31, are connected to the external devices in response to user inputs.

In step S250, the disconnection simulation module 36 simulates an action of removing the external device from the PCIE slot 10 and detects the interface information of all PCIE slots connected to the external devices and the information of the connected external devices, wherein the information of removed external device and the interface information of removed PCIE slot are defined as simulation pulled information.

In step S260, the reconnection simulation module 37 simulates an action of re-inserting or replacing the external device, the removal of which has been simulated, into the same PCIE slot and detects the interface information of all PCIE slots connected to the external devices and the information of the connected external devices.

In step S270, the determination module 38 compares the first information detected by the disconnection simulation module 36, and the second information detected by the reconnection simulation module 37 with the third information acquired by the acquiring module 33.

In step S275, if the determination module 38 determines that both the first information detected by the disconnection simulation module 36 and the second information detected by the reconnection simulation module 37 are the same as the third information acquired by the acquiring module 33, the test result of the PCIE slot is a pass.

In step S280, if the determination module 38 determines that one of the first information detected by the disconnection simulation module 36 and the second information detected by the reconnection simulation module 37 is different from the third information acquired by the acquiring module 33, the test result of the PCIE slot is a fail.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A test apparatus comprising:
at least one PCIE slot;
a storage unit to store interface information of each of the at least one PCIE slots; and
a processing unit comprising:
a detecting module to detect one of the at least one PCIE slots which is connected to an external device;
an allocating module to allocate a configuration space for the external device according to the PCIE standard when the detecting module detect that the PCIE slot is connected to the external device, wherein the configuration space stores information of the external device;
an acquiring module to acquire the interface information of the PCIE slot connected to the external device from the storage unit and the information of the connected external device from the configuration space; wherein the interface information of the PCIE slots and the information of the external devices acquired by the acquiring module is defined as a first information;
a disconnection simulation module to simulate an action of removing the external device from the PCIE slot and detect interface information of all PCIE slots connected to the external devices and information of the connected external devices, wherein the information of removed external device and the interface information of removed PCIE slot are defined as simulation pulled information; wherein the interface information of the PCIE slots, the information of the external devices, and the simulation pulled information detected by the disconnection simulation module is defined a second information;
a reconnection simulation module to simulate an action of re-inserting or replacing the external device removed by the disconnection simulation module into the PCIE slot removed by the disconnection simulation module and detect interface information of all PCIE slots connected to the external devices and information of the connected external devices; wherein the interface information of the PCIE slots and the information of the external devices detected by the reconnection simulation module is defined as a third information; and
a determination module to compare the second information detected by the disconnection simulation module and the third information detected by the reconnection simulation module with the first information acquired by the acquiring module to obtain a test result of the PCIE slot connected to the external device.

2. The test apparatus as recited in claim 1, wherein:
when the determination module determines that both the second information detected by the disconnection simulation module and the third information detected by the reconnection simulation module are the same as the first information acquired by the acquiring module, the test result of the PCIE slot is a pass; and
when the determination module determines that one of the second information detected by the disconnection simulation module and the third information detected by the reconnection simulation module is different from the first information acquired by the acquiring module, the test result of the PCIE slot is a fail.

3. The test apparatus as recited in claim 1, wherein the processing unit further comprises a display module and a selecting module, the display module is configured to display the interface information of the PCIE slots connected to the external devices and the information of the connected external devices, and the selecting module is configured to select a PCIE slot from the PCIE slots connected to the external devices detected by the detecting module in response to user inputs to simulate.

4. The test apparatus as recited in claim 1, wherein the configuration space of the external device further comprises information of the PCIE slot as to bit status, the detecting module is configured to detect whether a PCIE slot is connected to an external device based on the bit status of the PCIE slot, when the bit status of the PCIE slot is a first value, the detecting module detects that the PCIE slot is connected to an external device, and when the bit status of the PCIE slot is a second value, the detecting module detects that the PCIE slot is not connected to an external device.

5. The test apparatus as recited in claim 1, wherein the configuration space of each external device further comprises three interrupt sources, a register value of each interrupt source, and power control bit information, the disconnection simulation module is configured to acquire three interrupt sources from the configuration space of each connected external device, change the register value of each interrupt source to shield each interrupt source, and change the power control bit information to power off the PCIE slot connected to the external device to simulate the action of removing the external device from the PCIE slot.

6. The test apparatus as recited in claim 1, wherein the configuration space of each external device further comprises three interrupt sources, a register value of each interrupt source, and power control bit information, the reconnection simulation module is configured to acquire three interrupt sources from the configuration space of each connected external device, change the register value of each interrupt source to open each interrupt source, and change the power control bit information to power on the PCIE slot connected to the external device to simulate the action of re-inserting or replacing the external device removed by the disconnection simulation module into the PCIE slot removed by the disconnection simulation module.

7. A method of testing PCIE slot for a test apparatus, wherein the test apparatus comprises at least one PCIE slot and stores interface information of each of the at least one PCIE slot, the method comprising:
detecting one of the at least one PCIE slot which is connected to an external device;
allocating a configuration space for the external device according to the PCIE standard when detecting that the PCIE slot is connected to the external device, wherein the configuration space stores information of the external device;
acquiring the stored interface information of the PCIE slot connected to the external device and the information of the connected external device from the configuration space; wherein the acquired interface information of the PCIE slots and the acquired information of the external devices is defined as a first information;
simulating an action of removing the external device from the PCIE slot and detecting a first interface information of all PCIE slots connected to the external devices and a first information of the connected external devices, wherein the information of removed external device and the interface information of removed PCIE slot are defined as simulation pulled information, the first interface information of the PCIE slots, the first information of the external devices, and the simulation pulled information is defined a second information;
simulating an action of re-inserting or replacing the removed external device into the removed PCIE slot and detecting a second interface information of all PCIE slots connected to the external devices and a second information of the connected external devices; wherein the second interface information of the PCIE slots and the second information of the external devices is defined as a third information; and
comparing the second information and the third information with the first information to obtain a test result of the PCIE slot connected to the external device.

8. The method as recited in claim 7, wherein:
when both the second information and the third information are the same as the first information, the test result of the PCIE slot is a pass; and
when one of the second information and the third information is different from the first information, the test result of the PCIE slot is a fail.

9. The method as recited in claim 7, further comprising:
when detecting a plurality of PCIE slots are connected to the external devices, displaying the interface information of the PCIE slots connected to the external devices and the information of the connected external devices, and;
selecting a PCIE slot from the plurality of PCIE slots to simulate in response to user inputs.

10. The method as recited in claim 7, wherein the configuration space of the external device further comprises information of the PCIE slot as to bit status, the step of detecting one of the at least one PCIE slot which is connected to an external device comprising:
detecting whether a PCIE slot is connected to an external device based on the status bit information of the PCIE slot;
if the bit status of the PCIE slot is a first value, detecting that the PCIE slot is connected to an external device, and;
if the bit status of the PCIE slot is a second value, detecting that the PCIE slot is not connected to an external device.

11. The method as recited in claim 7, wherein the configuration space of the external device further comprises three interrupt sources, a register value of each interrupt source, and power control bit information, the step of simulating an action of removing the external device from the PCIE slot and detecting a first interface information of all PCIE slots connected to the external devices and a first information of the connected external devices comprises:
acquiring three interrupt sources of the configuration space of each connected external device, changing the register value of each interrupt source to shield each interrupt source, and changing the power control bit information to power off the PCIE slot connected to the external device.

12. The method as recited in claim 7, wherein the configuration space of the external device further comprises three interrupt sources, a register value of each interrupt source, and power control bit information, the step of simulating an action of re-inserting or replacing the removed external device into the removed PCIE slot and detecting a second interface information of all PCIE slots connected to the external devices and a second information of the connected external devices comprises:
acquiring three interrupt sources of the configuration space of each connected external device, changing the register value of each interrupt source to open each interrupt source, and changing the power control bit information to power on the PCIE slot connected to the external device.
